(19) United States
(12) Patent Application Publication
(10) Pub. No.: US 2026/0228100 A1
(43) Pub. Date: Aug. 6, 2026

(54) METHODS AND SYSTEMS FOR DYNAMICALLY CONTROLLING RESOURCE AVAILABILITY

(71) Applicant: The Toronto-Dominion Bank, Toronto (CA)

(72) Inventors: Jin Hyuck YIM, Richmond Hill (CA); Murtaza OFFICEWALA, New York, NY (US); Michael KOKOLIS, Lincroft, NJ (US)

(73) Assignee: The Toronto-Dominion Bank, Toronto (CA)

(21) Appl. No.: 19/042,223

(22) Filed: Jan. 31, 2025

(51) Int. Cl. G06F 11/30

(52) U.S. Cl. CPC G06F 11/3072; G06F 11/3051

(57) ABSTRACT

A processor-implemented method and system are described. The method may include: detecting an upcoming resource event to occur on a computer system; determining, based on an occurrence of a resource event on the computer system, an event dependency on the upcoming resource event; and providing, at a resource availability interface, an interface feature based on the event dependency, wherein the interface feature includes an indication of an upcoming resource allocation based on a projected resource condition.

### FIELD

The present disclosure relates to computing resources and, more particularly, dynamically controlling resource availability within computer systems.

### BACKGROUND

Computer systems often have limited amounts of resources that are maintained at suboptimal levels. When available resources are insufficient to meet a demand or are otherwise suboptimal, a variety of problems can occur within computer systems. For example, a lack of available memory within a computer system can cause the computer system to become unresponsive and crash. As another example, insufficient available network bandwidth may cause performance issues, delays, or failures. By way of another example, depletion of available battery power in mobile devices can lead to unexpected shutdowns, power failures, or a loss of battery life. As yet another example, high central processing unit usage may result in overheating or thermal throttling.

It would be advantageous to provide for enhanced dynamic control of resource availability that meets demand while reducing under or over provisioning of resources.

### BRIEF DESCRIPTION OF THE DRAWINGS

Reference will now be made, by way of example, to the accompanying drawings which show example embodiments of the present application, and in which:

FIG. 1 shows a schematic diagram illustrating an operating environment of an example embodiment according to the subject matter of the present application;

FIG. 2A shows a high-level schematic diagram of the client device, first computing system and second computing system of FIG. 1;

FIG. 2B shows a simplified organization of software modules stored in a memory of the example computing systems of FIG. 2A;

FIG. 3 shows, in block diagram form, an example embodiment of the data store of FIG. 1;

FIG. 4 is a flowchart showing operations performed in controlling resource availability based on an expected time of day of a future resource event, according to an example embodiment;

FIG. 5 is a flowchart showing operations performed in controlling resource availability based on an expected time of day of a future resource event, according to another example embodiment;

FIG. 6 is a flowchart showing operations performed in controlling resource availability based on an expected time of day of a future resource event, according to yet another example embodiment;

FIG. 7 is an example graphical user interface including a notification of a time of day of a projected resource condition, according to an example embodiment; and

FIG. 8 is an example graphical user interface including an alert indicating a time of day to take an action;

Similar reference numerals may have been used in different figures to denote similar components.

### DETAILED DESCRIPTION OF EXAMPLE EMBODIMENTS

In one aspect, the present application describes a system. The system may include a communications module; one or more processors coupled to the communications module; and a memory coupled to the one or more processors. The memory may store instructions that, when executed by the system, cause the system to detect a future resource event to occur on the computer system; determine, based on an occurrence of a past resource event on the computer system, an expected time of day of the future resource event; and provide, at a resource availability interface, an interface feature based on the expected time of day of the future resource event, wherein the interface feature includes at least one of: a notification of a time of day of a projected resource condition; or an indication of a time of day to take an action.

In some implementations, the instructions, when executed by the system, that cause the system to detect the future resource event to occur on the system may further cause the system to determine an expected date of the future resource event based on historical data for the occurrence of the past resource event on the system.

In some implementations, the instructions, when executed by the system, that cause the system to detect the future resource event to occur on the system may further cause the system to receive, from a second system, a second notification including a defined date of the future resource event and excluding a defined time of day of the future resource event.

In some implementations, the notification of the time of day of the projected resource condition may include a notification of a time of day when a resource level is expected to fall below a threshold.

In some implementations, the indication of the time of day to take the action may include an indication of a time of day at which to perform a resource transfer from the computer system to a second computer system.

In some implementations, the instructions that cause the computer system to detect the future resource event to occur on the computer system may further cause the computer system to identify a recurring resource event on the computer system.

In some implementations, the future resource event may include a future positive adjustment event.

In some implementations, the future resource event may correspond to a future resource demand.

In some implementations, the future resource event may be or include a future resource transfer event for a real-time resource transfer between the computer system and a second computer system.

In some implementations, the action may include dynamically scaling a resource.

In yet another aspect, the system may include a communications module; one or more processors coupled to the communications module; and a memory coupled to the one or more processors and storing instructions that, when executed by the computer system, cause the computer system to: detect an upcoming resource event to occur on the computer system; determine, based on an occurrence of a resource event on the computer system, an event dependency on the upcoming resource event; and provide, at a resource availability interface, an interface feature based on the event dependency, wherein the interface feature includes an indication of an upcoming resource allocation based on a projected resource condition.

In some implementations, the interface feature may further include an indication of a time of day to take an action.

In some implementations, the indication of the time of day to take the action may include an indication of a time of day at which to perform a resource transfer from the computer system to a second computer system.

In some implementations, the instructions that cause the computer system to detect the upcoming resource event to occur on the computer system may further cause the computer system to determine an expected date of the upcoming resource event based on historical data for the occurrence of the resource event on the computer system.

In some implementations, the instructions that cause the computer system to detect the upcoming resource event to occur on the computer system may further cause the computer system to receive, from a second computer system, a notification including a defined date of the upcoming resource event and excluding a defined time of day of the upcoming resource event.

In some implementations, the indication of the upcoming resource allocation based on the projected resource condition may include a time of day when a resource level is expected to fall below a threshold.

In some implementations, the instructions that cause the computer system to detect the upcoming resource event to occur on the computer system may further cause the computer system to identify a recurring resource event on the computer system.

In some implementations, the upcoming resource event may include an upcoming positive adjustment event.

In some implementations, the upcoming resource event may correspond to an upcoming resource demand.

In some implementations, the upcoming resource event may be or include an upcoming resource transfer event for a real-time resource transfer between the computer system and a second computer system.

In yet another aspect, the present application describes a computer-implemented method. The computer-implemented method may include detecting a future resource event to occur on a computer system; determining, based on an occurrence of a past resource event on the computer system, an expected time of day of the future resource event; and providing, at a resource availability interface, an interface feature based on the expected time of day of the future resource event, wherein the interface feature includes at least one of: a notification of a time of day of a projected resource condition; or an indication of a time of day to take an action.

In some implementations, detecting the future resource event to occur on the computer system may include determining an expected date of the future resource event based on historical data for the occurrence of the past resource event on the computer system.

In some implementations, detecting the future resource event to occur on the computer system may include receiving, from a second computer system, a second notification including a defined date of the future resource event and excluding a defined time of day of the future resource event.

In some implementations, detecting the future resource event to occur on the computer system may include identifying a recurring resource event on the computer system.

In yet another aspect, the computer-implemented method may include detecting an upcoming resource event to occur on a computer system; determining, based on an occurrence of a resource event on the computer system, an event dependency on the upcoming resource event; and providing, at a resource availability interface, an interface feature based on the event dependency, wherein the interface feature includes an indication of an upcoming resource allocation based on a projected resource condition.

In some implementations, detecting the upcoming resource event to occur on the computer system may include determining an expected date of the upcoming resource event based on historical data for the occurrence of the past resource event on the computer system.

In some implementations, detecting the upcoming resource event to occur on the computer system may include receiving, from a second computer system, a notification including a defined date of the upcoming resource event and excluding a defined time of day of the upcoming resource event.

In some implementations, detecting the upcoming resource event to occur on the computer system may include receiving, from a second computer system, a notification including a defined date of the upcoming resource event and excluding a defined time of day of the upcoming resource event.

In yet another aspect, present application describes a non-transitory computer-readable storage medium comprising processor-executable instructions which, when executed, may configure one or more processors to detect a future resource event to occur on a computer system; determine, based on an occurrence of a past resource event on the computer system, an expected time of day of the future resource event; and provide, at a resource availability interface, an interface feature based on the expected time of day of the future resource event, wherein the interface feature includes at least one of: a notification of a time of day of a projected resource condition; or an indication of a time of day to take an action.

In yet another aspect, present application describes a non-transitory computer-readable storage medium comprising processor-executable instructions which, when executed, may configure one or more processors to detect an upcoming resource event to occur on a computer system; determine, based on an occurrence of a resource event on the computer system, an event dependency on the upcoming resource event; and provide, at a resource availability interface, an interface feature based on the event dependency, wherein the interface feature includes an indication of an upcoming resource allocation based on a projected resource condition.

In yet a further aspect, the present application describes a non-transitory computer-readable storage medium storing processor-readable instructions that, when executed, configure one or more processors to perform any of the methods described herein. Also described in the present application is a computing device comprising: one or more processors, memory, and an application containing processor-executable instructions that, when executed, cause the one or more processors to carry out at least one of the methods described herein. In this respect, the term processor is intended to include all types of processing circuits or chips capable of executing program instructions.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, reference may be made to the terms “automatic” or “automatically”. These terms may cover an action or operation that does not require outside (human or machine) intervention in order to be triggered, performed, and/or completed. In some embodiments, these terms may cover an action or operation that may be triggered, performed, and/or completed without manual input via, for example, a manual input device.

In the present application, reference may be made to the term “real-time”. In at least some embodiments, real-time is defined as being within seconds. Certain factors, such as network traffic, may limit the immediacy of real-time transfers and/or processing of resource demands.

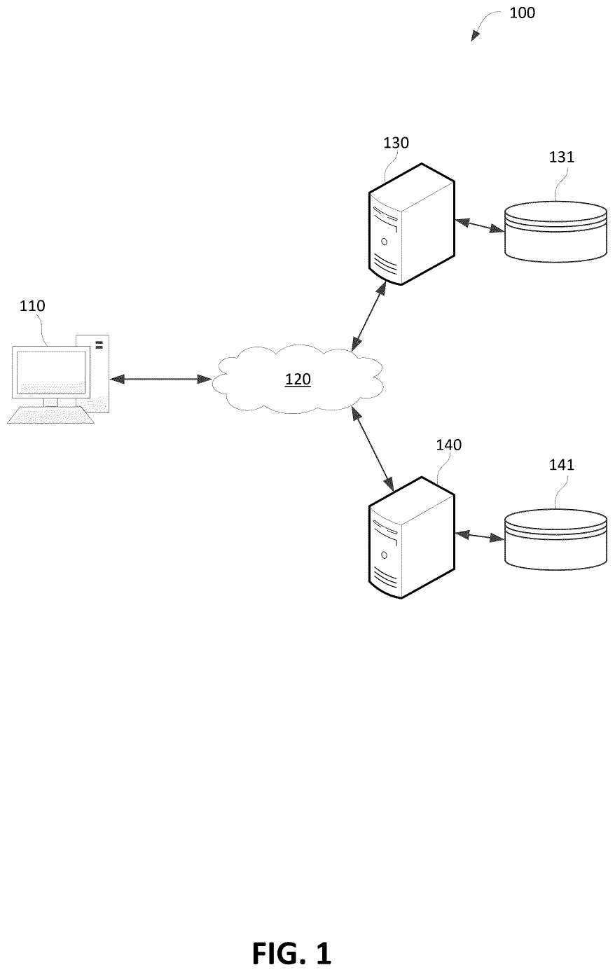

FIG. 1 shows a schematic diagram illustrating an operating environment 100 of an example embodiment. The operating environment 100 in this example includes a client device 110, first system 130, and second system 140. In some embodiments, the operating environment may include one or more client devices or a plurality of client devices, which may include the client device 110.

The client device 110 may be associated with an entity, such as a user of the client device 110. In some embodiments, the operator of the client device 110 may be an employee of the entity. The entity may have one or more profiles and/or accounts that may be stored in a data store 131 associated with, provided by and/or corresponding to the first computing system 130. Each profile may also include a record that may be or represent account data or other data maintained by the first system 130. The record may include data of various types and the nature of the data will depend on the nature of the first system 130. By way of example, in some implementations, the record may include, for example, documents and/or other data stored or uploaded by, or on behalf of a user. Such documents and/or data may include, for example, any one or more of: user preferences, indications of consent or authorization, digital identity data such as stored identity information or documentation, transactional information, or other types of documents and/or data. The transactional information may include historical data transfers for the account.

The first system 130 may be configured to verify authentication information received from the client device 110 as corresponding to one or more profiles, accounts and/or authentication data maintained by the first system 130.

In some embodiments, the first system 130 may provide a front-end interface that allows the client device 110 to interact with the first system 130. For example, the first system 130 may provide one or more graphical user interfaces (GUIs) to the client device 110. By way of example, the first system 130 may provide, to the client device 110, a user interface for uploading data or transmitting notifications in an authenticated session. The user interface provided to the client device 110 may be an interface for receiving user input associated with a resource request, including a resource demand. A resource demand may indicate a transfer of a resource between the account associated with the first system 130 and the account associated with the second system 140 and/or a request for a transfer of a resource.

The first system 130 may be configured to automatically identify projected overload events with respect to an account and may identify when an overload event is projected to occur. In some embodiments, the system may identify an overload event by monitoring notifications received by the system and detecting future resource events based on those notifications.

The first system 130 may be managed, operated, controlled by and/or associated with an entity that is an agent of a first account holder, which may be a user of the client device 110. The client device 110 may be managed, operated or controlled by the first account holder. The first account holder may be a customer (e.g. a corporate/business customer) or client of the entity or otherwise associated with the entity. In some embodiments, the first account holder is a requestee or transferor of a data or resource transfer.

The first system 130 may allocate, consume, maintain, track, manage, and/or provide computing resources to the entity associated with the client device 110. A computing resource may be of a variety of types. The computing resources may, for example, be memory or processor cycles. In some embodiments, the computing resource may be a network resource, such as, for example, bandwidth. In some embodiments, the computing resource is a storage resource, such as memory that is used for long-term storage, including for example non-transitory storage such as space in a hard disk drive (HDD), solid state disk drive (SSDD), etc. In some embodiments, a resource may be or include stored value, such as a digital asset, which may be represented in a data store. For example, the first computing system 130 may be coupled to a data store 131, which may be provided in secure storage. The secure storage may be provided internally within the first computing system 130 or externally. The secure storage may, for example, be provided remotely from the first computing system 130. For example, the secure storage may include one or more data centers. The first system 130 may store data regarding one or more resources in data store 131.

The first system 130 may further store data regarding users or customers associated with the first system 130 in first data store 131. The first data store 131 may include records associated with a plurality of entities. For example, the records may be for a plurality of accounts and at least some of the records may define or store resources. For example, the records may define a quantity of resources. For example, the entity that is associated with the client device 110 may be associated with an account having one or more records in the database. The records may reflect a quantity of stored resources that are associated with the entity. Such resources may include owned resources and, in at least some embodiments, borrowed resources. The resources that are associated with an entity may be grouped into various buckets. Some such buckets may, for example, represent individual resource accounts. For example, an entity may be associated with one or more resource accounts. At least some of the resources may be borrowed, supplemental, or scaled resources. The resources may, for example, represent an amount of a resource that is available for transfer, use or consumption. The entity that is associated with the client device 110 and the account may be a customer of an institution that operates or manages the first computing system 130.

The first system 130 may have access to other data such as, for example, resource availability data and/or historical resource or event data. Such data may be stored in the database 180 or in another storage system and/or may be accessed from another resource associated with the first computing system 130 such as, for example, one or more processors which may provide real-time resource availability data.

The first computing system 130 may also store data regarding a mapping of an identifier associated with a resource demand (e.g. a transferor, recipient and/or account identifier) to an identifier of the second system 140 (e.g. an Internet Protocol (IP) address or domain name). The mapping may be stored in the first data store 131.

The second system 140 may be managed, operated, controlled by and/or associated with an entity that is an agent of a second account holder. The second account holder may also be a customer (e.g. a corporate/business customer) or client of the entity or otherwise associated with the entity. In some embodiments, the second account holder is a requestor or transferee of a data transfer.

The second system 140 may further store data regarding users or customers associated with the second system 140 in second data store 141. The second data store 141 may include records associated with a plurality of entities. For example, the records may be for a plurality of accounts and at least some of the records may define or store resources. For example, the records may define a quantity of resources.

The first and second systems 130, 140 may be or include a transfer processing system. A transfer processing system may include a transfer processing module implemented as a software module and configured to process a transfer such as a transfer identified in a transfer message. By way of example, the processing module or system may be configured to perform internal transfers by transferring a resource or value between two different records in the first data store 131 (i.e., between two accounts at the same institution or entity) and/or to perform external transfers by interacting with one or more other third-party systems, such as, for example, second system 140. Internal and/or external transfers may be performed using various real-time methods, protocols, interfaces and/or techniques. In some implementations, at least some transfers may be performed by interacting with other systems via a third-party network. A transfer may be successfully processed and completed when value/resources have been successfully transferred from a transferor account to a recipient account. The processing system may track and store data identifying completed transfers.

As illustrated, the first system 130 is in communication with the client device 110 and second system 140 via the network 120. The client device 110, first system 130 and/or second system 140 may be configured to transmit and receive messages between each other.

The client device 110, first system 130, and second system 140 may be configured to ingest data from each other and may transmit requests, replies, alerts, notifications, configuration objects, or other data to each other. The first and second systems 130, 140 may store data in the first and second data stores 131, 141, respectively. The client device 110 may obtain data stored in the data store 131 via the first system 130. The first and second data stores 131, 141 are illustrated as single units for ease of illustration, but may include a plurality of storage units and, in some cases, storage media connected via the network 120.

The client device 110 is a computing device and may be configured to receive input and display output. It may, as illustrated, be a desktop computer. However, the client device 110 may be a computing device of another type such as, for example, a mobile device, a smartphone, a laptop computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The first and second systems 130, 140 may be or include a computer system such as a computer server system, database management system, resource management system, data transfer system, or resource transfer systems. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, web servers, email servers, file transfer protocol (FTP) servers, compute servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The client device 110, first system 130, and second system 140 may be in geographically disparate locations.

The network 120 is a computer network. The network 120 may be an internetwork such as may be formed of one or more interconnected computer networks. For example, such a network may be or may include an Ethernet network, an asynchronous transfer mode (ATM) network, a wireless network, or the like. In some implementations, the network 120 may be the Internet. One example of a wireless network is a cellular network. Another example of a wireless network is a close proximity (i.e. personal area) wireless network, sometimes referred to as a wireless personal area network (WPAN). Examples of WPANs include Bluetooth™ and Zigbee™. The network 120 may facilitate communication between the client device 110, first system 130 and second system 140.

As further described below, the client device 110, first system 130 and second system 140 may be configured with software to perform associated functions such as those described herein.

FIG. 1 illustrates the first system 130, and second system 140, and data stores 131, 141 as separate and distinct computing devices. However, these systems may not all be separate physical systems. For example, the first system 130 and the data store 131 may be implemented on a common physical device. As another example, the second system 140 and the data store 141 may be implemented on a common physical device. One or more of the client device 110, first system 130 and second system 140 may be managed, operated, and/or controlled by a same entity. For example, the second system 140 may include the client device 110, and a same entity may manage and control the second system 140 and client device 110. In this case, that same entity may have profiles with both the first and second systems 130, 140, and the client device 110 may be used to manage transfers between a first resource account included in the first system 130 and a second resource account included in the second system 140, where the first and second resource accounts define resources held by that same entity and the first and second resource accounts are included in profiles corresponding to that same entity.

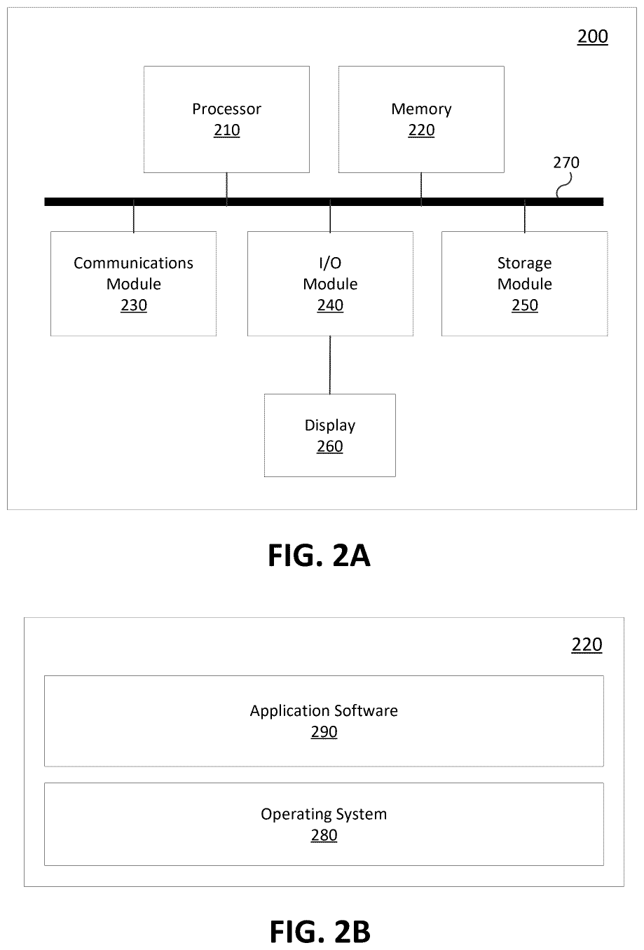

FIG. 2 is a high-level schematic diagram of an example computing device 200. In some embodiments, the example computing device 200 may be exemplary of the client device 110, first system 130 and/or the second system 140 in the example operating environment 100 of FIG. 1.

The example computing device 200 includes a variety of modules. A module may include one or more modules and may be a subsystem and/or include an interface. In some cases, a module is a hardware module and may be integrated into or include an electronic circuit.

As illustrated, the example computing device 200 may include a processor 210, a memory 220, a communications module 230, an I/O module 240, a storage module 250 and/or a display f. As illustrated, the foregoing example modules of the example computing device 200 are in communication over a bus 270. As such, the bus 270 may be considered to couple the various modules of the client device 110 to each other, including, for example, to the processor 210.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computing device 200.

The communications module 230 allows the example computing device 200 to communicate with other computing devices and/or various communications networks such as, for example, the network 120. For example, the communications module 230 may allow the example computing device 200 to send or receive communications signals. The communications module may be or include a network adapter, which may be wired or wireless. Communications signals may be sent or received according to one or more protocols or according to one or more standards. The communications module 230 may allow the example computing device 200 to communicate via one or more wireless networks, such as for example, a cellular wireless network, according to one or more standards such as, for example, Global System for Mobile Communications (GSM), Code Division Multiple Access (CDMA), Evolution Data Optimized (EVDO), Long-term Evolution (LTE), or 5G. Additionally or alternatively, the communications module 230 may allow the example computing device 200 to communicate via a wireless personal area network (WPAN) via some combination of one or more networks or protocols such as, for example, Bluetooth™ and Zigbee™. In some embodiments, all or a portion of the communications module 230 may be integrated into a component of the example computing device 200. For example, the communications module 230 may be integrated into a communications chipset or circuit.

The I/O module 240 is an input/output module. The I/O module 240 allows the client device 110 to receive input from and/or to provide input to components of the example computing device 200 such as, for example, various input modules and output modules. For example, the I/O module 240 may, as shown, allow the example computing device 200 to receive input from and/or provide output to the display 260.

The storage module 250 allows the example computing device 200 to store and retrieve data and, in some embodiments, may be referred to as a data store or data facility. In some embodiments, the storage module 250 may be formed as a part of the memory 220 and/or may be used to access all or a portion of the memory 220. Additionally or alternatively, the storage module 250 may be used to store and retrieve data from persisted storage other than the persisted storage (if any) accessible via the memory 220. In some embodiments, the storage module 250 may be used to store and retrieve data in/from a database. A database may be stored in persisted storage. Additionally or alternatively, the storage module 250 may access data stored remotely such as, for example, as may be accessed using a local area network (LAN), wide area network (WAN), personal area network (PAN), and/or a storage area network (SAN). In some embodiments, the storage module 250 may access data stored remotely using the communications module 230. In some embodiments, the storage module 250 may be omitted and its function may be performed by the memory 220 and/or by the processor 210 in concert with the communications module 230 such as, for example, if data is stored remotely. The storage module 250 is illustrated as a single unit for ease of illustration, but may include a plurality of storage units.

The example computing device 200 may include or be connected to a display 260. The display 260 is a module of the example computing device 200. The display 260 is for presenting graphics and displaying graphical user interfaces. The display 260 may be, for example, a liquid crystal display (LCD). In addition to being an output device, the display 260 may also be an input device. For example, the display 260 may allow touch input to be provided to the example computing device 200.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

FIG. 2B depicts a simplified organization of software modules stored in the memory 220 of the example computing device 200 of FIG. 2. As illustrated, these software modules include an operating system 280 and application software 290.

The operating system 280 is software. The operating system 280 allows the application software 290 to access the processor 210, the memory 220, the communications module 230, the I/O module 240, and the storage module 250 of the example computing device 200. The operating system 280 may be, for example, Google™ Android™, Apple™ iOS™, UNIX™, Linux™ Microsoft™ Windows™, Apple OSX™, Linux™ distribution, or the like.

The application software 290 adapts the example computing device 200, in combination with the operating system 280, to operate as a device performing particular functions.

The application software 290 may include an image processing module that may be engaged to convert image data of text into machine-encoded or machine-readable text. The conversion of image data to machine-encoded or machine-readable text may use techniques such as optical character recognition (OCR). In some embodiments, the image processing module may be considered an OCR module and may be included in an OCR application for converting image data of text into machine-encoded or machine-readable text.

The application software 290 may include an application for configuring the computing device 200 to receive application programming interface requests from a computer system. The software module may include or use one or more application programming interfaces (APIs). An application programming interface may perform operations to service the application programming interface requests. The application programming interface requests may define parameters. In some cases, the application programming interface may facilitate communication between software modules and may be capable of transferring data or resources between software modules.

The application software 290 may include an application for configuring the computing device 200 to transmit application programming interface requests or replies to a computer system. The application may include, provide or use an application programming interface (API) to communicate with, offer services to, and/or receive services from, another application, program, or software component. More particularly, the application programming interface be used to connect to and transfer data or resources to and/or from one or more computer systems. The example computing device 200 may store connection data associated with the application programming interface, such as an identifier identifying a computing device or system. In some cases, the identifier may be or include a server identifier, such as, for example, an Internet Protocol (IP) address or domain name. The identifier may be used in conjunction with the application programming interface to establish a connection with the computing system.

The application programming interface may utilize a particular messaging protocol, for example, Simple Object Access Protocol (SOAP). To use the application programming interface, the application may generate a message in conformity with a protocol for invoking the application programming interface.

The application programming interface may be capable of and/or configured to perform resource transfers in real-time or facilitate a real-time transfer. The application programming interface may utilize a particular messaging protocol that supports real-time resource transfers. The application may generate and/or receive messages in conformance with a particular messaging protocol or format for invoking the application programming interface.

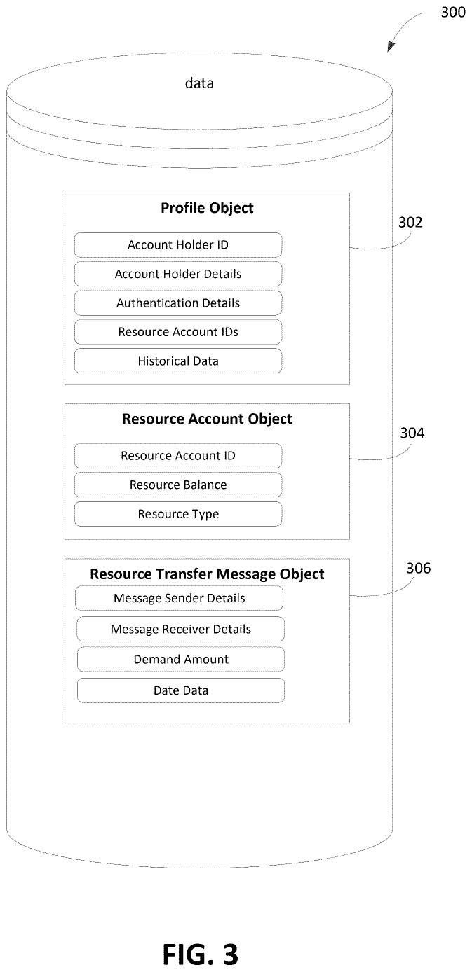

Reference is now made to FIG. 3, which partially illustrates an example data store 300 in block diagram form. The data store 300 may be a first or second data store 131, 141 of the first or second system 130, 140 of FIG. 1. Not all components of the data store 300 are illustrated. The data store 300 may include one or more data storage units. In some cases, the stored data may be in a database format and may include one or more databases. The databases may be relational databases in some examples. The data store 300 may store data regarding one or more profile objects 302, resource account objects 304, and resource transfer message objects 306, each of which may be a data structure.

The data store 300 may store data regarding an account holder in a profile object 302. In some embodiments, the account holder may be or represent a user or customer. For instance, the account holder may correspond to a user of a client device 110 and/or first or second system 130, 140 of FIG. 1. The profile object 302 may include details related to the account holder, such as authentication details, one or more resource account identifiers, historical data, and resource demand details. A resource account identifier may correspond to a particular resource account object 304.

Example details related to an account holder include an account holder identifier indicating a particular person or entity, identification information (e.g. full name, including first and last name), contact information (e.g. phone number, email address, street address), and messaging information (e.g. phone number, email address).

Authentication details may include sign in or one more credentials such as, for example, username, password, access card number, shared secret, and/or biometric data such as a fingerprint, voiceprint and/or facial profile data. Authentication may be performed based on one or more credentials.

Historical data may include historical transfer data for transfers of resources to and/or from a resource account corresponding to the profile.

The data store 300 may further store data regarding a resource account associated with a profile in a resource account object 304. The resource account object 304 may include a resource account identifier identifying a resource account. A resource account may hold or store resources for transfer to another resource account and may be a demand deposit account.

A resource account object 304 may also include an amount and/or type of resources associated with the resource account. The amount may reflect a quantity of resources that are available at any given time. Such resources may include owned resources and, in at least some embodiments, borrowed resources (e.g., resources obtained and made available via a loan). The quantity of resources that are available to or associated with a user may be reflected by a balance defined in an associated data record such as, for example, a resource account balance. The resource account balance may indicate an amount of resources available for immediate use or transfer by the account holder and/or from the resource account. An amount of a resource may be defined using a standard unit of measure. In some embodiments, a standard unit of measure for processor resources may be referred to as “processor units”.

The resources may be computing resources, which may be or include memory, network bandwidth, battery power, and/or processor cycles. The resources may take other forms in other implementations. By way of example, the resources that are associated with a resource account may be or may represent tokens, digital assets, physical assets, data, database assets, cryptocurrencies, value indicators, bandwidth, documents, images, photographs, streaming video, streaming audio, or other resources.

The data store 300 may further include a resource transfer message object 306 that may store data regarding a resource transfer, resource demand, or resource transfer request. The resource transfer message object 306 may store details regarding one or more parameters included in a resource transfer message. Example parameters that may be included in a resource transfer message include: a resource transfer identifier identifying the particular resource transfer request or demand; message sender details (e.g. account holder identifier corresponding to account holder requesting the transfer; resource account identifier corresponding that account holder identifier); message receiver details (e.g. account holder identifier corresponding to account holder that accepts the resource transfer message); a demand or transfer amount (e.g. an amount of resources demanded and/or to be transferred); date data (e.g. demand amount due date or transfer deadline) and/or routing data for routing a reply message in response to the resource transfer message. The reply message may facilitate fulfillment of the resource demand and/or complete a resource transfer.

The routing data may include: identification information of the first and/or second system and/or the entity associated with, operating or managing the first and/or second system (e.g. a system identifier); and/or identification information of a first and/or second logical storage area, for example, a logical storage area identifier (e.g. a resource account identifier), associated with, managed or controlled by a respective first and/or second account holder to or from which the amount of resources is to be transferred. A logical storage area may be or include an area of the data store 300. A logical storage area may further be or represent a resource account or other logical storage area for storing an amount of a resource. The routing data may be used to route a resource transfer between two computer systems and, more particularly, from one computer system to another computer system.

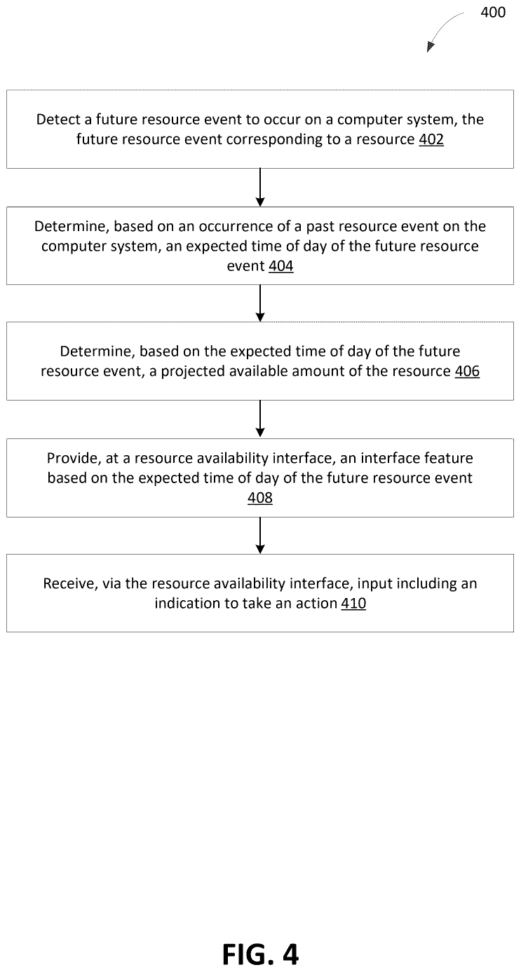

Reference will now be made to FIG. 4 which illustrates an example method 400 controlling resource availability based on an expected time of day of a future resource event. The method 400 may be implemented by one or more computer systems suitably programmed to carry out the functions described. The operations of the example method 400 may be performed by one or more computer systems which may be of the type described herein. In some embodiments, the operations may be performed by the first system 130 of FIG. 1, which may cooperate and communicate with a client device 110 and/or a second system 140 of FIG. 1 to perform the method 400 or a variation thereof.

In operation 402, the computer system detects an upcoming resource event, which may be or include a future resource event. The future resource event may be a computing event. In some embodiments, a computing event may be an event that occurs internal to one or more computing systems, including the computer system. A computing event may include one or more operations performed by the computer system. The future resource event may correspond to a resource.

In some embodiments, the future resource event may include a future resource adjustment event. The adjustment event may include a performance of a database operation to reflect an adjustment of an amount of resources available in a resource account. The adjustment may be in the amount of the supplemental amount and the resource account may be the identified resource account.

The resource adjustment event may be a positive or negative adjustment event. For example, a positive adjustment event may include a performance of a database operation to reflect an addition of an amount of resources available in a resource account. In contrast, a negative adjustment event may include a performance of a database operation to reflect a subtraction of an amount of resources available in a resource account.

In some embodiments, the future resource event may be a transfer event. An example of a transfer event may include processing a transfer. The transfer may represent a transfer of an amount of a resource from one resource account to another.

Where the event is a resource transfer event, the computer system may cause the transfer event to occur by, for example, processing a transfer message to complete a transfer and/or fulfil a request for transfer. The transfer message may be a computer-readable message configured for transmission over one or more computer networks between a sending device and a receiving device. The transfer message may be a structured message having a defined schema or set of predefined fields to contain data. The transfer message may be used to transfer resources from one entity to another entity. In particular, the transfer message may be used to effect a change in recorded ownership of resources.

The transfer message may be specially formatted to include parameters of a transfer. The parameters may be included as metadata in the transfer message. Where the transfer message is a real-time message, the parameters may be included in a real-time protocol format. The parameters may include resource definition data. By way of example, the resource definition data may define a resource that is stored in or otherwise associated with a record associated with a transferor or recipient.

The transfer message may, in some implementations, be or include a request to transfer. A request to transfer may be a specially formatted message that is sent from a first transfer processing system to a second transfer processing system. The request to transfer may be sent from the first transfer processing system to the second transfer processing system over a transfer protocol that is used for facilitating transfers between databases associated with different transfer processing systems. For example, the first transfer processing system may be associated with a first database and the second transfer processing system may be associated with a second database. The databases may store account data. That is, the databases may store data that is associated with various accounts. In at least some implementations, each record in the database may be associated with a particular one of these accounts.

A request to transfer may be a message that is sent on behalf of a recipient to initiate a transfer from a sender to the recipient. That is, the request to transfer is sent, on behalf of the recipient, from the transfer processing system associated with the recipient to the transfer processing system associated with the sender. The request to transfer requests a transfer from an account, for example a user account and/or a resource account, that is associated with the sender to an account that is associated with the recipient. The request to transfer includes one or more identifiers that identify the account associated with the sender and/or the record associated with the recipient. The identifier(s) may be or include an account number. The request to transfer may also include one or more identifiers that identify the transfer processing system associated with the sender and/or that identify the transfer processing system associated with the recipient. Such identifiers may be or include an entity or institution identifier.

The request to transfer may be a transfer initiation message. That is, the request to transfer may be an initial message that may be used to cause a transfer to occur. Since the request to transfer is initiated by a recipient rather than a sender, the request to transfer may be considered to a pull-style transfer, which may be contrasted with typical push-style transfers. In at least some implementations, the request to transfer may be formatted as an ISO20022 message.

In some embodiments, the future resource event may be an unscheduled event. More particularly, computer system may not schedule the future resource event to occur. In other words, the future resource event may occur without being scheduled by the computer system to occur on a particular and/or at a particular time of day. The detection of the future resource event may be performed without determining that the future resource event is scheduled, by the computer system and/or another computer system, to occur on a particular day and/or at a particular time of day.

In operation 404, the computer system may determine, based on an occurrence of a past resource event on the computer system, an event dependency on the upcoming resource event. The event dependency may be or include an expected time of day of the upcoming resource event. The past resource event may be, for example, a resource transfer event or a resource adjustment event.

The computer system may determine the expected time of day of the future resource event based on historical data for the past resource event. The historical data for a resource event may include a timestamp indicating a historical time of day at which the resource event occurred. The historical time of day may be used as the expected time of day of the future resource.

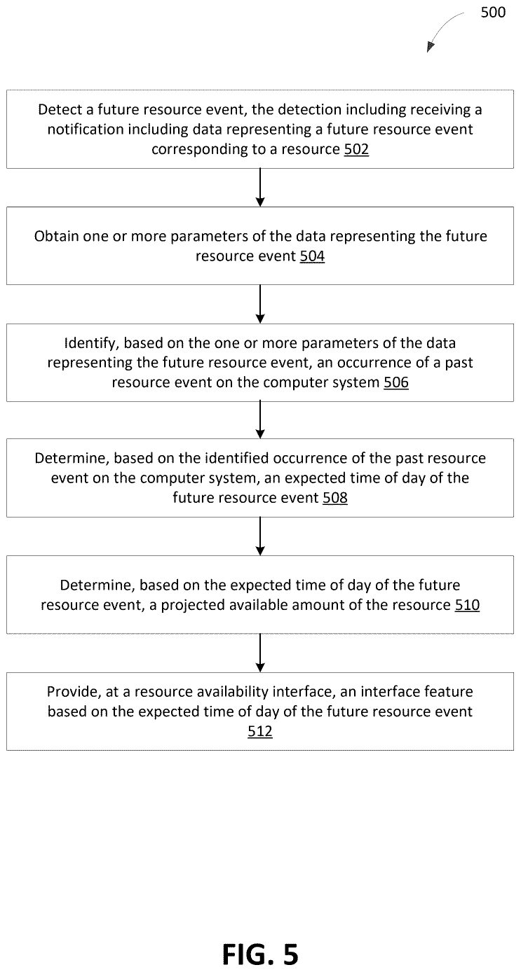

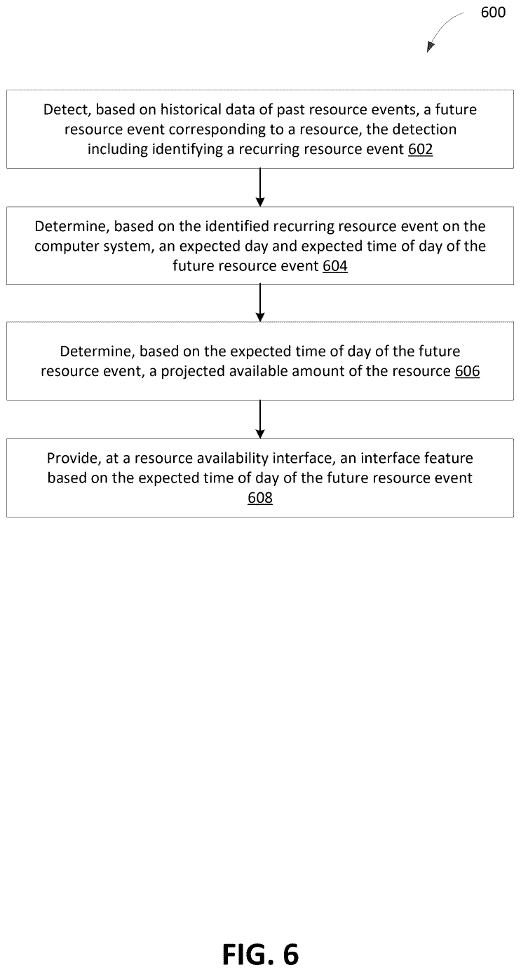

The past resource event may be identified using one or more techniques, such as, for example, those implemented in the methods 500, 600 of FIGS. 5 and 6.

In operation 406, in response to determining the event dependency on the upcoming resource event, the computer system may determine, based on the event dependency on the upcoming resource event, a projected available amount of the resource. In some embodiments, this operation may include, in response to determining the expected time of day of the future resource event, the computer system may determine, based on the expected time of day of the future resource event, a projected available amount of the resource. The determination may be made by determining a projected amount of the resource available over time. A current available amount of the resource may be used as a starting point to which the future resource event may be applied. The current available amount may be a current balance or amount of the resource available in a resource account. The projected available amount may be calculated by applying the future resource event to the current available resource amount. For example, if the future resource event is a negative resource adjustment event or a resource demand event, the projected available amount may be calculated by subtracting a negative adjustment amount or a demand amount corresponding to the event from the current available amount. On the other hand, if the future resource event is a positive resource adjustment event or a resource transfer event for receiving resource, the projected available amount may be calculated by adding a positive adjustment amount or a transfer amount corresponding to the current available resource amount.

In some embodiments, the projected available resource amount may be determined based a plurality of future resource events. The computer system may use one or more techniques described herein to detect the plurality of future resource events and determine an expected time of day of each particular future resource event in the plurality of resource events. For example, a first technique may be used to detect a first subset of the plurality of future resource events and determine an expected time of day of each particular future resource event in the first subset of the plurality of future resource events, whereas a second technique may be used to detect a second subset of the plurality of future resource events and determine an expected time of day of each particular future resource event in the second subset of the plurality of future resource events, wherein the first and second subset are distinct from each other.

Where the projected available resource amount is based on the plurality of detected future resource events, the projected available amount may be calculated by applying the plurality of future resource events to the current available resource amount in chronological order of their respective expected time of day. The computer system may determine a respective projected available resource amount for each particular expected time of day of the plurality of future resource events. In this way, the computer system may generate a sequence or series of projected available resource amounts based on the plurality of detected future resource events, where each particular projected available resource amount corresponds to a respective time of day. The plurality of future resource events may include one or more different types of events. For example, one or more of the future resource events may include one or more positive resource adjustment events and one or more negative resource adjustment events.

In some cases, the computer system may detect a projected overload condition. An overload condition may be detected if the projected demand corresponding to the one or more future resource events exceeds the projected available amount of the resource at a particular time of day. The particular time of day may be one of the times of day of the one or more detected future resource events.

Detecting an overload condition may include detecting a projected shortfall event. A projected shortfall event may, for example, be detected when a level of an available resource amount is expected to fall below a threshold or is projected to be insufficient to satisfy the one or more detected future resource events. If a shortfall event for the resource is projected to occur at a point in time, then the system has detected a projected overload condition.

In operation 408, the computer system may provide, at a resource availability interface, one or more interface features based on details of the event dependency, the upcoming resource event, and/or projected resource condition. In particular, an interface feature may be based on the event dependency on the upcoming resource event. The interface feature may include a notification or indication of an upcoming resource reallocation based on the projected resource, details of an event dependency on the upcoming resource event, and/or details of an expected date or time of day of the upcoming resource event.

An interface feature may be pre-populated with data or parameters associated with, corresponding to, or included in the detected upcoming resource event. An interface feature may also solicit input and facilitate one or more selections from one or more options. In some cases, an interface feature may require active selection of an option, field, or setting. An interface feature may be implemented using one or more user interface elements, including menus, buttons, icons, radio buttons or option buttons, checkboxes, or other selectable graphical elements for initiating various operations in connection with the data transfer. An interface feature may include text boxes or other graphical elements for receiving input of text information, including numbers, for example, an amount of money, for use in various operations in connection with the data transfer. An interface feature may also include text, labels, images or other graphical elements for displaying information in the user interface.

In at least some embodiments, a user interface element may be invoked, actuated or otherwise selected by a user. Selection of a user interface element can include a user input operation on the user interface element to provide a signal or instruction to a browser application or other executing application that a selection of the user interface element has been made by the user and/or that a particular action represented by the user interface element is to be carried out. Different forms of selection, for example, by a touch, gesture, pointing device, or voice command, will be known to those skilled in the art. In some cases, a command, action, or operation associated with the user interface element can be invoked by user input selecting or otherwise acting on a user interface element.

In some embodiments, the computer system may provide the interface feature in the form of an indication or notification, which may include one or more interface features. The indication or notification may include details of the upcoming future resource event, which may include an expected time of day of the detected future resource event, and/or a time of day when a resource level is expected to fall below a threshold. Details of the future resource event may be provided directly by including the details in the notification, or indirectly by including a link to the details. The link may include or correspond to a uniform resource locator (URL).

The notification may be triggered when a projected overload condition is detected and/or when there is expected to be a resource shortfall at a particular time of day. In some embodiments, the computer system may notify a user of a client device when an amount of resources held by resource account is expected to fall below a threshold, for example, zero, and/or when the available resource amount is projected to be insufficient at a particular time of day. The notification may even indicate the time of day at which the shortfall event is expected to occur. The notification may also facilitate a resource transfer to be made to correct or avoid the shortfall. The notification may also facilitate scaling an amount of a resource to control the resource availability.

The computer system may transmit the notification to a client device based on the future resource event. The computer system may use a messaging address to transmit the notification to the client device. In some embodiments, the messaging address may be obtained from a user account. The user account may be identified based on the future resource event. For example, the future resource event may correspond to a resource amount corresponding to a resource account included in a user profile, which may be a user account.

The transmission of the notification may be performed in accordance with any suitable means of communication. In some embodiments, the communication may be implemented using a messaging paradigm, such as email, text message, instant message, automated telephone call, or messaging to an application relating to the identified account. Information of the identified user account may be used to transmit the notification to the client device. In some embodiments, the computing system may transmit the notification to the client device using a messaging address, for example, an email address and/or a telephone number, associated with the identified one or more accounts.

The notification may be provided in different forms and the contents or message of the notification may vary. The notification may include information of the identified user account, such as the account identifier. The notification may also include details of a resource demand, resource account, and/or identified user account. In some embodiments, the message may be a rich Hypertext Transfer Protocol (HTTP) email, pure text email or short messaging service (SMS) message.

The identified user account may be associated with the client device. For instance, the client device may be configured with information of the identified user account in order to receive notifications from the computing system. In some embodiments, the client device may include an email application that is configured to receive emails addressed to an email address of the identified account. The client device may also be configured to receive text messages and telephone calls at a telephone number of the identified account. In some embodiments, the client device may be configured to receive a notification via an application that relates to the identified account and is installed on the client device. The application may be, for example, a resource management application that is configured with credentials (e.g. a username and password) of the identified account for authenticating the application with the computer system. The computer system may transmit the notification to the authenticated resource management application.

The client device may present the notification to a user of the client device via a user interface. The user interface may be that of a messaging application, such as an email application, text and/or voice message application, instant message application, or an application relating to the identified account. In some embodiments, the user interface may be a graphical user interface that presents the notification via pop-up, alert, or in any other suitable manner. The notification may present details of the future resource event. The notification may also prompt for input including an indication to take an action. The prompt may be presented as a link, button or other actionable user interface element and may include text.

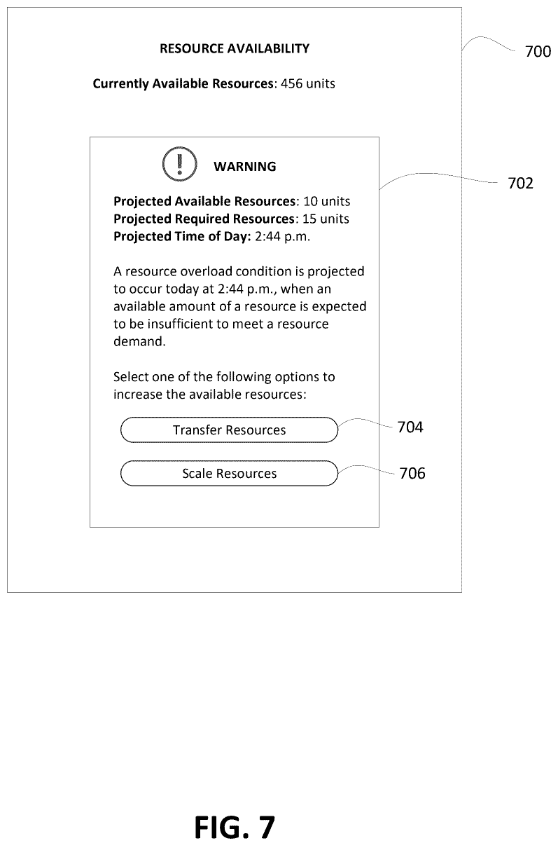

Referring briefly to FIG. 7, an example resource interface 700 is illustrated. The resource interface 700 may be displayed on a display of the computing device. The resource interface 700 may include, for example, text populated with a resource amount indicating an amount of a resource currently available. The resource amount may be updated by the computer system in real-time to provide an indication of the amount of the resource available at the current time.

The resource amount may be expressed in various forms. In some cases, the available resource amount may be expressed as a number of units, such as a quantity of memory. In some cases, the available resource amount may be expressed as a percentage. For example, where the resource is battery power, the level of the available amount of the battery may be expressed as a percentage of total battery power when a battery of the computer system is fully charged.

The resource interface 700 may include one or more features provided by the notification and/or generated based on the detected future resource event. The resource interface 700 includes notification feature 702 for a projected overload condition. The notification feature 702 includes pre-populated text indicating a projected amount of available resources of 10 units, a projected amount of resources required of 15 units, and a corresponding projected time of day of 2:44 p.m. The projected amount of resources required may correspond to a future resource event that is detected to occur at the projected time of day.

The notification feature 702 also includes a first selectable option 704 and a second selectable option 706. The selectable options 704, 706 may be activated in order to trigger the computer system to take one or more actions. For example, the first selectable option 704 may be activated to trigger the computer system to initiate a resource transfer in order to, for example, process and initiate fulfillment of a resource demand. By way of another example, the second selectable option 706 may be activated to trigger the computer system to initiate scaling an amount of a resource. The selectable options 704, 706 may be associated with a reference or uniform resource identifier (URI) that links to the computer system. The selectable options 704, 706 may be links for triggering the computing device to send to the computer system an indication to take one or more respective actions.

The resource interface 700 may facilitate taking one or more actions without requiring input of one or more pre-populated fields included one or more interface features. The pre-populated data may include one or more parameters required to trigger or initiate the detected future resource event. By way of example, one or more parameters that are included in a resource demand may be included in the notification so that the user of the client device does not have to manually input such parameters. In some implementations, the resource demand may define a resource and an amount of a resource. In this way, the user of the computing device may authorize fulfillment or servicing of a resource demand or resource scaling request without inputting information defining the time of day to perform such an action.

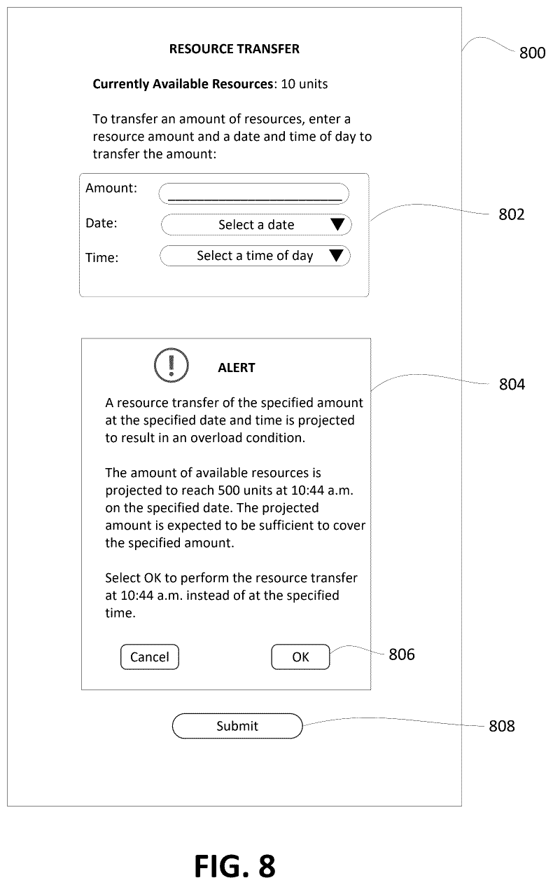

Referring briefly to FIG. 8, an example resource interface 800 is illustrated. The resource interface 800 may be displayed on a display of the computing device.

The resource interface 800 includes a section 802 for transferring an amount of resources on a selected date and at a specified time. The section 802 may include an option for uploading a resource transfer amount. The section 802 may also permit the selection or entry of a date associated with the resource transfer. The date may define a date on which the resource transfer is to occur. The section 802 may also permit the selection or entry of a time of day associated with the resource transfer. The time of day may define a time at which the resource transfer is to occur.

The section 802 may include additional fields that are not shown in FIG. 8. For example, the section 802 may include one or more user interface elements for receiving input and uploading data representing one or more parameters of a resource transfer message. For example, the section 802 may include an input area for receiving data representing routing data for the resource transfer message.

The alert feature 804 may include one or more features provided by the notification and/or generated based on the detected future resource event. The alert feature 804 may be displayed via the resource interface 800 in response to the notification.

In some embodiments, the notification may be provided in response to input of a time of day in the section 802. For example, in response to a selection of a time of day in section 802, the computing device displaying the interface may automatically transmit the data input in section 802 to the computer system. The computer system may determine, based on a projected resource amount and the input data, that an overload condition is projected to occur at the input time of day. The computer system may determine, based on a projected available amount of the resource and/or based on the input amount, a suggested alternative date and/or time of day at which to perform the resource transfer without triggering an overload condition. The notification may include the suggested alternative date and/or time of day.

The alert feature 804 may include one or more features provided by the notification or generated based on the detected future resource event. The alert feature 804 includes pre-populated text indicating a projected amount of available resources of 500 units and a corresponding suggested time of day of 10:44 am. The alert feature 804 also includes an acceptance selectable option 806 for using the suggested date and/or time of day to schedule an action. The acceptance selectable option 806 may be activated to accept the suggested date and/or time of day and replace the input date and/or time of day.

The resource interface 800 may also include a submission selectable option 808. For example, the submission selectable option 808 may be activated to trigger the sending of the data entered in the section 802, and the suggested date and/or time of day, from the client device to the computer system performing the method 400 of FIG. 4. In some embodiments, the computer system may use the suggested date and time of day to schedule one or more actions to, for example, transfer resources. The submission selectable option 808 may be associated with a reference or uniform resource identifier (URI) that links to the computer system. The submission selectable option 808 may be a link for triggering the computing device to send to the computer system an indication to take one or more actions.

In this way, the expected time of day of the future resource event, as well as the projected available amount of the resource, may by used to facilitate scheduling a time for outgoing resource transfers, to avoid resource shortfalls. For example, when an outgoing resource transfer is being configured, the computer system may trigger an alert and/or suggestion of a time of day at which the resource transfer should take place based on projecting a time when sufficient resources will be available.

Referring back to FIG. 4, in operation 408, the computer system may receive, via the resource availability interface, input including an indication of actuation of a selectable option to take one or more actions.

The one or more actions may be taken in response to receiving the input and may cause a resource event to occur on the computer system in real-time in connection with a resource. The event may be a resource event that is distinct from the detected future resource event and may correspond to a different resource demand and/or resource transfer. The action may be a scheduled or unscheduled and taken immediately. The resource may be, or correspond to, a resource corresponding to the detected future resource event.

The one or more actions may include dynamically scaling a resource, generating a resource transfer message, performing a transfer of resources, and/or scheduling an action to occur at a time of day determined based on the future resource event. The one or more actions may be performed in real-time in response to receiving the input via the resource availability interface.

Scaling the resource may include scaling the resource corresponding to a projected overload condition by allocating a supplemental amount of resources to a resource account corresponding to the identified user account. In some embodiments, fulfilling the resource scaling request may include performing a database operation to reflect an adjustment of an amount of resources available in a resource account. The adjustment may be in the amount of the supplemental amount. The supplemental amount may be based on or equal to an amount of a projected shortfall of the resource. In this way, the computer system may scale a resource by dynamically allocating resources to match demand. In some cases, the supplemental amount of resources may be borrowed resources.

In some embodiments, the computer system may generate a resource transfer message formatted in a real-time transfer format. The transfer message may represent a transfer of a resource from one account to another. The transfer message may be used to transfer resources from another computer system to the computer system to mitigate the projected overload event and avoid a shortfall. The amount of the resource transferred may be based on or equal to an amount of a projected shortfall of the resource.

Reference will now be made to FIG. 5 which illustrates an example method 500 for controlling resource availability based on an expected time of day of a future resource event. The method 500 may be a modification or implementation of the method 400 of FIG. 4. One or more operations of the method 500 of FIG. 5 may correspond to one or more operations of the method 400 of FIG. 4.

In operation 502, the computer system detects an upcoming resource event. The operation 502 may correspond to an operation 402 of the method 400 of FIG. 4. The detection may include receiving a notification including data representing a future resource event and detecting the notification. The notification may be received by the computer system from a second computer system. In some embodiments, the operations of the second computer system may be performed by the second computer system 140 of FIG. 1. The notification may include a defined date of the future resource event and exclude a defined time of day of the future resource event.

The data representing the future resource event include one or more electronic documents. Such electronic documents and/or data may include, for example, any one or more of: digital media including image, video and/or sound data, photographs, text-based documents, resource demand data such as stored resource demand information or documentation, or other types of documents and/or data. An electronic document may be prepared according to a standardized file format such as, for example, Portable Document Format (PDF) or a media format such as, for example, Joint Photographic Experts Group (JPEG or JPG). An electronic may be, for example, a resource demand, request for transfer, invoice, or contract.

The electronic document may correspond to a transfer message that is received after the detection of the future resource event. In some embodiments, the electronic document may include details of a future resource transfer message yet to be received by the computer system. Example details may include an identifier corresponding to the future resource event. The identifier may by an identifier identifying a resource transfer message. Example details may also include one or more parameters of the future resource transfer message. In some embodiments, the resource transfer message may include a request for immediate transfer of a resource in real-time and may include, such as, for example, a date on which the transfer is requested to occur, which may be the date on which the future resource event is expected to occur. The electronic document may not include a time of day at which the transfer is requested to occur.

In operation 504, the computer system may obtain one or more parameters of the data representing the upcoming resource event. Example parameters that may be included in the data include a type of resource, routing data for performing a resource transfer to resource account and/or another computer system, a resource account identifier, a system identifier, an account holder, the date on which the future resource event is expected to occur on, one or more parameters of a transfer message, and/or one or more parameters of a resource demand message.

In cases where the electronic document is image data representing textual instructions, such as, for example, operation protocols, operation guidelines, instruction manuals, contracts, or invoices, the processor may execute OCR techniques, systems, methods, algorithms, or programming to convert the image data into machine-readable data and/or extract machine-readable data from the image data. The machine-readable data may include one or more parameters.

In operation 506, the computer system may identify, based on the one or more parameters of the data representing the upcoming resource event, an occurrence of a past resource event on the computer system. In some embodiments, the computer system uses the obtained one or more parameters to perform a search on historical data for a past resource event. The historical data may include data regarding a plurality of historical resource events, which may be, for example, historical resource transfer events. A historical resource transfer event may include one or more historical parameters. The computer system may compare a particular parameter of the obtained one or more parameters to a respective parameter in the one or more historical parameters. Based on the comparison, the computer system may identify a past transfer event. For example, the computer system may compare a type of resource, a resource account identifier, a system identifier, routing data, an account holder, and/or a date of the future resource event to the one or more historical parameters. Based on the comparison, the computer system may determine that one or more parameters of the data representing the future resource event match one or more historical parameters of a particular historical resource event in the historical data. The particular historical resource event located by the search may be referred to as the identified past resource event.

In operation 508, the computer system may determine, based on the identified occurrence of the past resource event on the computer system, an event dependency on the upcoming resource event. The event dependency may include an expected time of day of the upcoming resource event. The expected time of day of the future resource event may also be based on the notification and/or historical data. The historical data for the identified past resource event may include a timestamp indicating a historical time of day at which the resource event occurred. The historical time of day may be used as the expected time of day of the future resource. In some embodiments, the one or more operations 504, 506, 508 may correspond to an operation 404 of the method 400 of FIG. 4.

In operation 510, the computer system may determine, based on the event dependency or expected time of day of the future resource event, a projected available amount of the resource and, in operation 512, the computer system may provide, at a resource availability interface, an interface feature based on the event dependency or expected time of day of the future resource event. The interface feature may also be based on the projected available amount of the resource. The operations 510, 512 may correspond to operations 406, 408 of the method 400 of FIG. 4 and the method may continue as shown in FIG. 4. The system may perform at least some aspects of the method 400 in FIG. 4 in accordance with at least some aspects of the method 500 of FIG. 5.

Reference will now be made to FIG. 6 which illustrates another example method 600 for controlling resource availability based on an expected time of day of a future resource event. The method 600 may be a modification or implementation of the method 400 of FIG. 4. One or more operations of the method 600 of FIG. 6 may correspond to one or more operations of the method 400 of FIG. 4.

In operation 602, the computer system detects an upcoming resource event. The operation 602 may correspond to an operation 402, 502 of the methods 400, 500 of FIGS. 4 and 5. The detection may include identifying a resource event recurring on the computer system. Identifying the recurring resource event may include identifying a corresponding recurring resource transfer.

In some embodiments, the identification of a recurring resource transfer may be based on scheduling data. In some embodiments, the computer system may store data regarding a resource transfer and the data may include a flag that is used to indicate whether the transfer is a recurring one. The flag may include a value of a binary variable. The presence of the flag may enable a resource transfer to recur. The computer system may perform a search on a list of resource transfers to identify one or more resource transfers that are recurring.

In some embodiments, the identification of a recurring resource transfer may be based on scheduling data. The computer system may maintain scheduling data that tracks scheduled resource transfers. The scheduling data may indicate whether a resource transfer is scheduled to recur. The computer system may query the scheduling data to identify one or more recurring resource transfers.

In some embodiments, the computer system may not be aware that a resource transfer is scheduled to occur on a particular date before predicting the expected time of that resource transfer. This scenario may arise where a second computer system schedules a resource message to be sent by the second computer system to the first computer system on a recurring basis, which may trigger the resource event to recur on the first computer system. In this case, the computer system may receive the recurring message and store historical data regarding the recurring message and/or the recurring resource event. The computer system may detect the future resource event based on the historical data. By way of another example, the computer system may determine, based on the historical data, that a past resource event occurs periodically. The recurring past resource event may have a common parameter. For example, the recurring event may correspond to a resource transfer to a particular computer system and/or resource account. The recurrence pattern may be, for example, on a daily, weekly, or monthly basis. The computer system may detect the future resource event based on a determination that the past resource event has occurred periodically and, accordingly, is expected to occur again in the future.

In operation 604, the computer system may determine, based on historical data for an occurrence of the past resource event on the computer system and/or based on the identified recurring resource event on the computer system, an event dependency on the upcoming resource event. The event dependency may include an expected day and/or time of day of the upcoming resource event. By way of example, if a resource event typically occurs at nine a.m. on the first day of the month in response to a resource message received from a particular system, then the future resource event may be detected to occur at nine a.m. on the first day of the month again. In some embodiments, the computer system may identify a particular past occurrence of the recurring resource event and determine, based on the historical data, a time of day of the past occurrence of the resource event. That time of day may be used as the expected time of day of the future resource event.

In operation 510, the computer system may provide, at a resource availability interface, an interface feature based on the event dependency and/or expected time of day of the upcoming resource event. The operation 510 may correspond to an operation 408 of the method 400 of FIG. 4 and the method may continue as shown in FIG. 4.

In operation 606, the computer system may determine, based on the expected time of day of the upcoming resource event, a projected available amount of the resource and, in operation 608, the computer system may provide, at a resource availability interface, an interface feature based on the expected time of day of the future resource event. The interface feature may also be based on the projected available amount of the resource. The operations 606, 608 may correspond to operations 406, 408 of the method 400 of FIG. 4 and the method may continue as shown in FIG. 4. The system may perform at least some aspects of the method 400 in FIG. 4 in accordance with at least some aspects of the method 600 of FIG. 6.

In this way, in some embodiments, the computer system may: detect a future positive adjustment event; determine, based on historical data for a past positive adjustment event, an expected time of day for the future positive adjustment event; and provide, at an interface, an interface feature for controlling a resource balance on an intraday basis based on at least the expected time of day for the future positive adjustment event, wherein the interface feature includes a notification of a time of day when the resource balance is expected to fall below a threshold and/or an indication of a time of day at which an outgoing transfer should be made. In some embodiments, detecting the future positive adjustment event may include determining an expected date of the future positive adjustment event based on the historical data for the past positive adjustment event.

It will be appreciated that it may be that some or all of the above-described operations of the various above-described example methods may be performed in orders other than those illustrated and/or may be performed concurrently without varying the overall operation of those methods.

It will also be appreciated that some or all of the above-described operations of the various above-described example methods may be triggered by, or caused by, or performed in response to, one or more of the above-described operations, and may be performed in real-time (or substantially real-time) in response to one or more of the above-described operations and/or automatically without user input.

Although many of the above examples refer to an “object” when discussing a data structure, it will be appreciated that this does not necessarily restrict the present application to implementation using object-oriented programming languages, and does not necessarily imply that the data structure is of a particular type or format. Data structures may have different names in different software paradigms.

Example embodiments of the present application may focus on a particular type of resource. However, it is understood that the present application is not limited to any such embodiments and that the embodiments described with respect to a particular type of resource generally may be extended to other types of resources.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A computer system comprising:
a communications module;
one or more processors coupled to the communications module; and
a memory coupled to the one or more processors and storing instructions that, when executed by the computer system, cause the computer system to:
detect an upcoming resource event to occur on the computer system;
determine, based on an occurrence of a resource event on the computer system, an event dependency on the upcoming resource event; and
provide, at a resource availability interface, an interface feature based on the event dependency, wherein the interface feature includes an indication of an upcoming resource allocation based on a projected resource condition.

2. The computer system of claim 1, wherein the interface feature further includes an indication of a time of day to take an action.

3. The computer system of claim 2, wherein the indication of the time of day to take the action includes an indication of a time of day at which to perform a resource transfer from the computer system to a second computer system.

4. The computer system of claim 1, wherein the instructions that cause the computer system to detect the upcoming resource event to occur on the computer system further cause the computer system to determine an expected date of the upcoming resource event based on historical data for the occurrence of the resource event on the computer system.

5. The computer system of claim 1, wherein the instructions that cause the computer system to detect the upcoming resource event to occur on the computer system further cause the computer system to receive, from a second computer system, a notification including a defined date of the upcoming resource event and excluding a defined time of day of the upcoming resource event.

6. The computer system of claim 1, wherein the indication of the upcoming resource allocation based on the projected resource condition includes a time of day when a resource level is expected to fall below a threshold.

7. The computer system of claim 1, wherein the instructions that cause the computer system to detect the upcoming resource event to occur on the computer system further cause the computer system to identify a recurring resource event on the computer system.

8. The computer system of claim 1, wherein the upcoming resource event includes an upcoming positive adjustment event.

9. The computer system of claim 1, wherein the upcoming resource event corresponds to an upcoming resource demand.

10. The computer system of claim 1, wherein the upcoming resource event is an upcoming resource transfer event for a real-time resource transfer between the computer system and a second computer system.

11. A computer-implemented method comprising:
detecting an upcoming resource event to occur on a computer system;
determining, based on an occurrence of a resource event on the computer system, an event dependency on the upcoming resource event; and
providing, at a resource availability interface, an interface feature based on the event dependency, wherein the interface feature includes an indication of an upcoming resource allocation based on a projected resource condition.

12. The method of claim 11, wherein the interface feature further includes an indication of a time of day to take an action.

13. The method of claim 12, wherein the indication of the time of day to take the action includes an indication of a time of day at which to perform a resource transfer from the computer system to a second computer system.

14. The method of claim 11, wherein detecting the upcoming resource event to occur on the computer system includes determining an expected date of the upcoming resource event based on historical data for the occurrence of the resource event on the computer system.

15. The method of claim 11, wherein detecting the upcoming resource event to occur on the computer system includes receiving, from a second computer system, a notification including a defined date of the upcoming resource event and excluding a defined time of day of the upcoming resource event.

16. The method of claim 11, wherein the indication of the upcoming resource allocation based on the projected resource condition includes a time of day when a resource level is expected to fall below a threshold.

17. The method of claim 11, wherein detecting the upcoming resource event to occur on the computer system includes identifying a recurring resource event on the computer system.

18. The method of claim 11, wherein the upcoming resource event includes an upcoming positive adjustment event.

19. (canceled)

20. A non-transitory computer-readable storage medium comprising processor-executable instructions which, when executed, configure one or more processors to:
detect an upcoming resource event to occur on a computer system;
determine, based on an occurrence of a resource event on the computer system, an event dependency on the upcoming resource event; and
provide, at a resource availability interface, an interface feature based on the event dependency, wherein the interface feature includes an indication of an upcoming resource allocation based on a projected resource condition.

21. The computer system of claim 1, wherein the upcoming resource event includes image data, and the detecting of the upcoming resource event to occur on the computer system includes using optical image recognition techniques to convert the image data into machine-readable data.
